(19) United States
(12) Patent Application Publication
(10) Pub. No.: US 2008/0018964 A1
(43) Pub. Date: Jan. 24, 2008

(54) APPARATUS AND METHOD FOR PROCESSING, STORING AND DISPLAYING DIGITAL IMAGES

(75) Inventors: Xiao-Guang Li, Shenzhen City (CN); Kuan-Hong Hsieh, Shenzhen City (CN); Hua-Dong Cheng, Shenzhen City (CN)

Correspondence Address: NORTH AMERICA INTELLECTUAL PROPERTY CORPORATION, P.O. BOX 506, MERRIFIELD, VA, 22116, US

(73) Assignees: ENSKY TECHNOLOGY (SHENZHEN) CO., LTD., Shenzhen City (CN); ENSKY TECHNOLOGY CO., LTD., Taipei Hsien (TW)

(21) Appl. No.: 11/780,485

(22) Filed: Jul. 20, 2007

(30) Foreign Application Priority Data
Jul. 21, 2006 (CN) 200610061749.2

(51) Int. Cl. H04N 1/46

(52) U.S. Cl. 358/531

(57) ABSTRACT

An apparatus for processing, storing and displaying digital images includes a processing unit (10), a display controller (30), a display unit (40) and a control panel (50). The processing unit modifies an original image from an original image file (210) according to modifying instructions received from the control panel, saves modifying parameters relating to the modification in an image modification file (220) that corresponds to the original image file. After the modification, if the original image is selected at a later time, the processing unit automatically modifies the original image according to the modifying parameters, thereby producing a modified image to be displayed on the display unit. A relating method for processing, storing and displaying digital image is also provided.

### TECHNICAL FIELD

The present invention relates to an apparatus and method for processing, storing, and displaying digital images.

### GENERAL BACKGROUND

Many tools are used during image processing, tools such as a personal computer to edit the image, a display, connected to the computer, to present the image, and tools to manipulate the displayed image. The image can be processed, such as resized, rotated, trimmed, text added, and the like. The processed image can be saved by replacing the original image or be saved separately from the original image.

Distortion is generally produced after edition of the image. For example, after being trimmed, the image quality is reduced. If the processed image is saved separately from the original image, storage space increases.

Therefore, there is a need for apparatus and method for processing, storing and displaying digital image which can solve at least the problems listed above.

### SUMMARY

A method for displaying digital images is provided, the method includes the step of: (a) reading original image data of an original image stored in an original image file; (b) reading modifying parameters from an image modification file that corresponds to the original image file; (c) modifying the original image according to the modifying parameters, thereby yielding a modified image; and (d) outputting the modified image on a display unit.

An apparatus for displaying digital images is provided, the apparatus includes a display unit; a processing unit; and an control panel; wherein, the processing unit receives an image selection signal from the control panel and reads original image data of a original image from an original image file according to the image selection signal, the processing unit reads modification parameters from an image modification file that corresponds to the original image file, the processing unit modifies the original image according to modification parameters to produce a modified image and outputs the modified image to the display unit.

Other advantages and novel features will be drawn from the following detailed description with reference to the attached drawings.

### BRIEF DESCRIPTION OF THE DRAWINGS

FIG. 1 is a schematic diagram of an apparatus for processing, storing and displaying digital images in accordance with a first embodiment of the present invention;

FIG. 2 is a schematic diagram of a processing unit of the apparatus of FIG. 1;

FIG. 3 shows contents of a storage of the apparatus of FIG. 1;

FIG. 4 is a schematic diagram of an apparatus for processing, storing and displaying digital images in accordance with a second embodiment of the present invention; and

FIG. 5 is a flowchart of a method for processing, storing and displaying digital images.

### DETAILED DESCRIPTION OF THE EMBODIMENTS

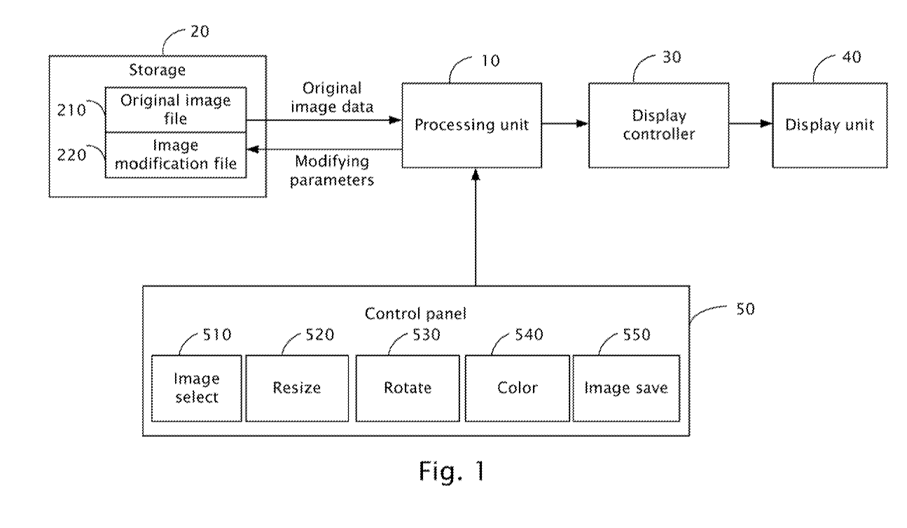

Referring to FIG. 1, an apparatus for processing, storing and displaying digital images (hereinafter “the apparatus”) in accordance with a first embodiment of the present invention is shown. The apparatus includes a processing unit 10, a storage 20, a display controller 30, a display unit 40, and a control panel 50. The control panel 50 includes a plurality of input units configured for receiving operational inputs and outputting operation instructions correspondingly. These input units may include but not limited to an image select button 510, a resize button 520, a rotate button 530, a color button 540, and an image save button 550. It must be stated that the “buttons” used here refer to all types of input devices that can be operated on to receive operational inputs and accordingly produce operation instructions. The “buttons” may be mechanic input devices, electronic input devices (e.g., touch panels) or software icons displayed on an interface. Accordingly, the operation instructions include but are not limited to image select instructions, modifying instructions (including zoom-in instructions, zoom-out instructions, rotate instructions, and color modification instructions), and save image instructions. These operation instructions can be produced through the image select button 510, the resize button 520, the rotate button 530, the color button 540, and the image save button 550.

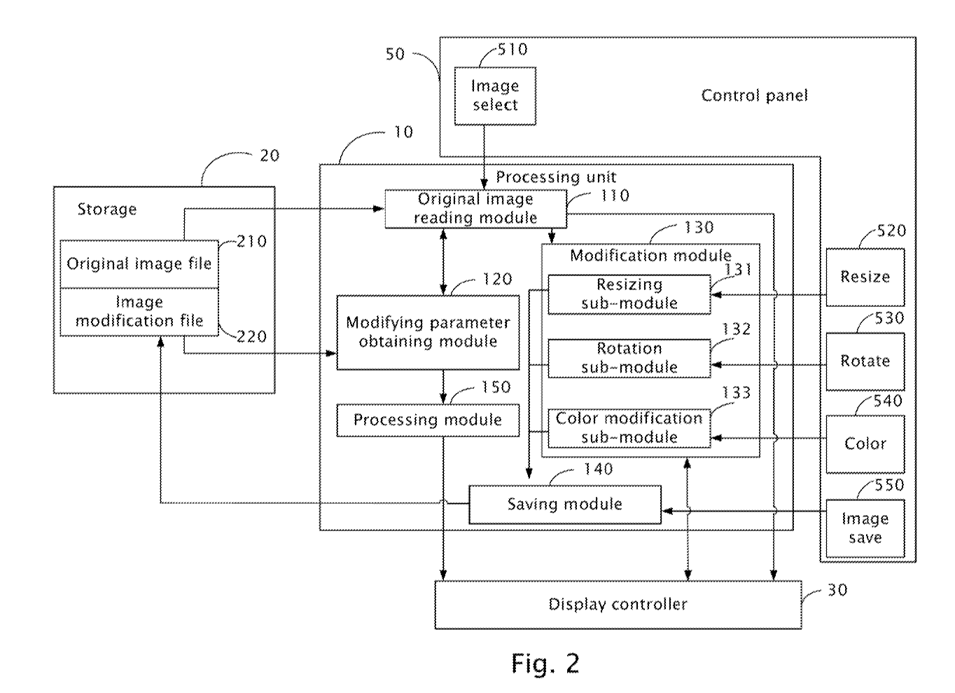

Referring also to FIG. 2, the processing unit 10 includes an original image data reading module 110 and a modification module 130. The original image data reading module 110 is configured for receiving the image select instructions from the image select button 510 of the control panel 50, searching the storage 20 for an original image file 210, and reading original image data from the original image file 210. The original image data reading module 110 is also configured for outputting an original image of the original image file 210 on the display unit 40 via the display controller 30.

When the modifying instructions are received from the control panel 50, the original image data reading module 110 transmits the original image data to the modification module 130 as a temporary image file. The modification module 130 is configured for modifying data of the temporary image file according to the modification instructions, thereby yielding modified image data. The modification module 130 is further configured for displaying a modified image of the modified image data on the display via the display controller 30. The control panel 50 includes the resize button 520, the rotate button 530, and the color button 540 that are configured for producing and transmitting the modifying instructions. The resize button 520, the rotate button 530, and the color button 540 are provided for illustration purpose only, and the control panel 50 may include other buttons used to produce and transmit the modifying instructions. The modification module 130 includes a resizing sub-module 131, a rotation sub-module 132, and a color modification sub-module 133. The resizing sub-module 131, the rotation sub-module 132 and the color modification sub-module 133 are also provided for illustration purpose only, and the modification module 130 may include other sub-modules used to modify data of the temporary image file according to the modifying instructions.

In particular, the resizing sub-module 131 is configured for modifying data of the temporary image file, such that an image size of the modified image is different than a size of the original image according to the zoom-in instructions and the zoom-out instruction from the resize button 520.

The rotation sub-module 132 is configured for modifying data of the temporary image file such that an orientation of the modified image can be rotated 90 degrees clockwise or 90 degrees counterclockwise relative to the original image according to the rotate instructions from the rotate button 530.

The color modification sub-module 133 is configured for modifying data of the temporary image file, such that a color of the modified image is different than a color of the original image according to the color modification instructions from the color button 540.

The processing unit 10 further includes a saving module 140. The saving module 140 is configured for receiving the save image instructions and for generating an image modification file according to the temporary image file and the original image file. The image modification file consists of at least one modifying parameter. In a first preferred embodiment, the at least one modifying parameter is a total modification result of the modified image relative to the original image of a same modifying instruction type. In a second embodiment, the at least one modifying parameter is a modification instruction transmitted by the control panel 50 and applied to the temporary image file.

As an overview, after the modifying parameters corresponding to an original image are stored, each time the original image is selected according to the image select instructions transmitted from the image selector button 510, a modified image derived from applying the modifying parameters on the original image is outputted and displayed on the display unit 40.

The processing unit 10 further includes a modifying parameter obtaining module 120 and a processing module 150. The original image reading module 110 reads the original image data from the original image file 210 according to the image select instructions transmitted by the image selector button 510. The modifying parameter obtaining module 120 obtains the modifying parameters from the image modification file 220 corresponding to the original image file 210. The processing module 150 processes the original image data according to the modifying parameters to produce the modified image and outputs the modified image to the display unit 40.

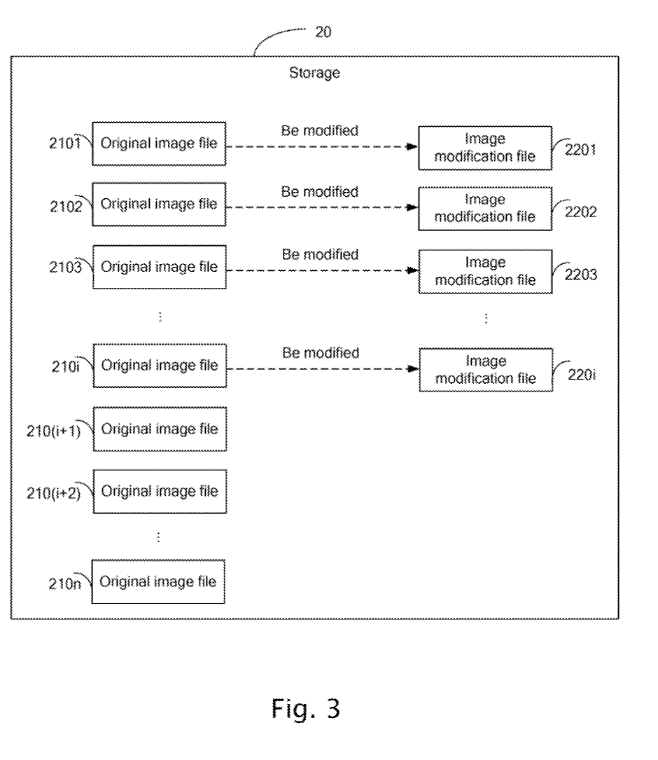

Referring to FIG. 3, in an exemplary embodiment, the storage 20 stores a plurality of original image files symbolically labeled from 2101 to 210n, among which, the original image files through 2101 to 210i have been processed and corresponding image modification files through 2201 to 220i has been saved in the storage 20, and the original image files through 210(i+1) to 210n remain unprocessed. Wherein, i and n are any natural number except 0, and n is greater than i. Therefore, when the image select instructions are received by the processing unit 10, the processing unit 10 reads the original image data from the original image file 210 according to the image select instructions. The processing unit 10 outputs the original image of the original image file 210 to the display unit 40 if the original image file 210 lists among the original image files 210(i+1)-210n. Or the processing unit 10 outputs the modified image to the display unit 40 if the original image file 210 lists among the original image files 2101-210i. The modified image is modified from the original image according to the modifying parameters recorded by the image modification file 220 that corresponds to the original image file 210.

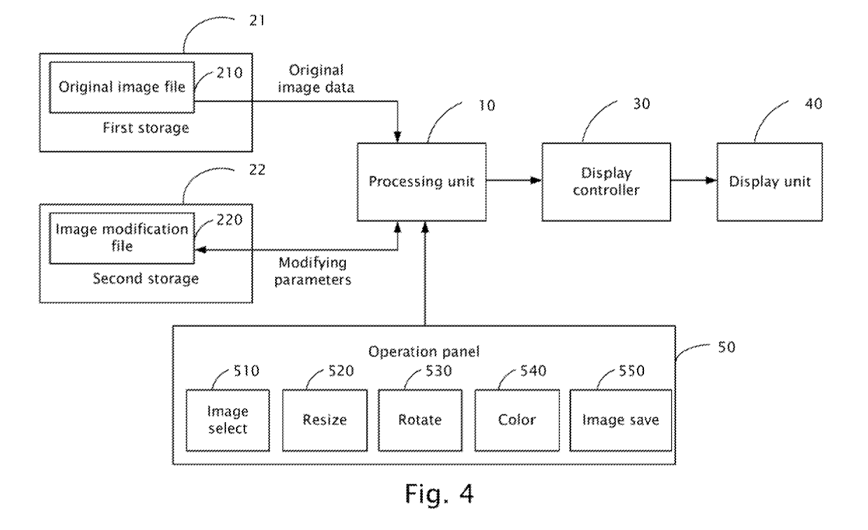

Referring to FIG. 4, according to a second embodiment of the apparatus, one or more original image files 210 (only one shown) are stored in a first storage 21 and one or more image modification files 220 (only one shown) are stored in a second storage 22.

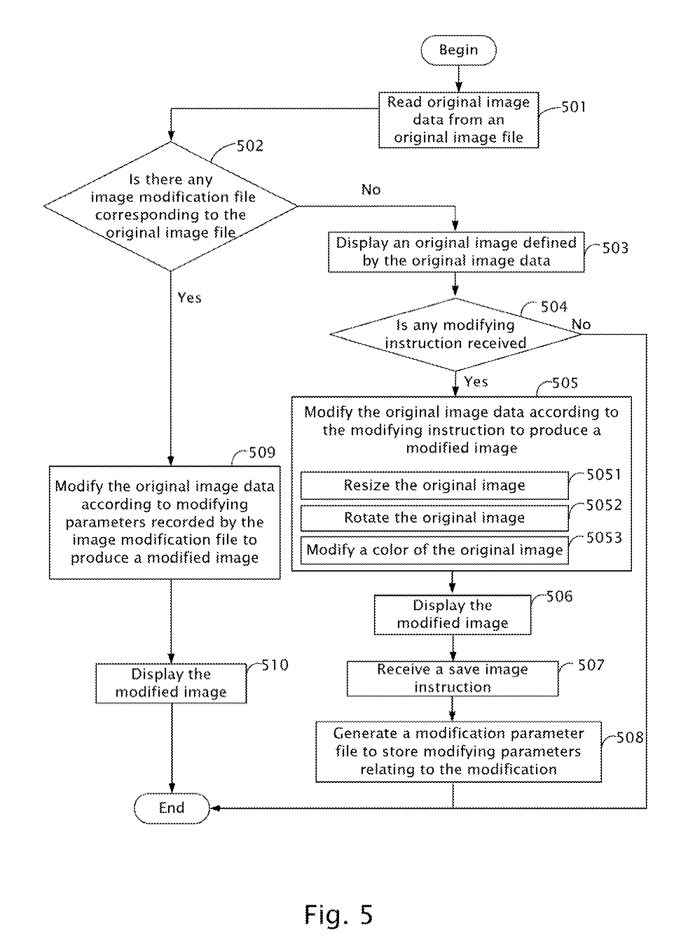

FIG. 5 is a flowchart of processing, storing and displaying digital images. The flowchart starts with step S501, the original image reading module 110 receives an image select instruction from the image selector button 510 and reads original image data from an original image file 210 according to the image select instruction, the original image reading module 110 signals the modifying parameter obtaining module 120 to obtain modifying parameters. In step S502 the modifying parameter obtaining module 120 determines whether an image modification file 220 that corresponds to the original image file 210 exists.

If the image modification file 220 does not exist, in step S503, the original image reading module 110 transmits the original image data to the display controller 30, thereby displaying an original image of the original image file 210 on the display unit 40. In step S504 the modification module 130 determines whether any modifying instruction is received and the procedure finishes if no modifying instruction is received. If any modifying instruction is received, the procedure advances to Step S505, the original image reading module 110 transmits the original image data as a temporary image file to the modification module 130, and the modification module 130 modifies data of the temporary image file according to the modifying instruction, thereby producing modified image data.

Step S505 may include one or more sub-steps depending on that the number of modification instructions is received. For example, Sub-steps S5051, S5052 and S5053 are included in Step S505 if a zoom-in instruction (or a zoom-out instruction), a rotate instruction and a color modification instruction are received. In Sub-step S5051 the resizing sub-module 131 modifies data of the temporary image file, such that an image size of a modified image of the modified data is different from a size of the original image according to the received zoom-in instruction (or zoom-out instruction). In Sub-step S5052 the rotation sub-module 132 modifies data of the temporary image file, such that the modified image is rotated by 90 degrees clockwise or counterclockwise relative to the original image according to the rotate instruction. In Sub-step S5053 the color modification sub-module 133 modifies data of the temporary image file, such that a color of the modified image is different from a color of the original image according to the color modification instruction. The modified image is accordingly produced by the modification module 130 in step S505 and displayed on the display unit 40 in Step S506 by the display controller 30. The saving module 140 receives a save image instruction from the enter button 550 in Step S507, and generates an image modification file 220 to record modifying parameters resulted by Step S505 in Step S508. The procedure then finishes.

If the image modification file 220 already exists according to step S502, the procedure advances to step S509, the modifying parameter obtaining module 120 obtains modifying parameters recorded by the image modification file 220 and the processing module 150 modifies the original image data according to the modifying parameters, so as to produce a modified image. The modified image is displayed on the display unit 40 in step S510 and the procedure accordingly finishes.

It must be stated that when the modified image is displayed on the display unit 40 and any modifying instruction is received from the control panel 50, a procedure similar to Steps S504-S508 described in FIG. 5 is implemented. The procedure is: a) the modification module 130 modifies data of the modified image to produce a second modified image displayed on the display unit 40; and b) the saving module 140 receives an save image instruction from the control panel 50, and updates the corresponding image modification file 220 with new modifying parameters resulted by a).

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A method for processing and storing digital images, comprising the steps of:
reading original image data of an original image from an original image file;
outputting an image on a displaying unit, the image being the original image or being a first modified image derived from the original image;
receiving modifying instructions from a control panel;
modifying data of the image according to the modifying instructions to produce a second modified image;
outputting the second modified image to the displaying unit; and
saving modifying parameters relating to the modification in an image modification file, the image modification file corresponding to the original image file.

2. The method as claimed in claim 1, wherein the modifying parameters comprise at least one total modification result of the second modified image relative to the original image of a same modifying instruction type.

3. The method as claimed in claim 1, wherein the modifying parameters comprise the modifying instructions.

4. The method as claimed in claim 1, further comprising the step of generating the image modification file before saving the modifying parameters in the image modification file.

5. A method for displaying digital image, comprising the steps of:
reading original image data of an original image stored in an original image file;
reading modifying parameters from an image modification file that corresponds to the original image file;
modifying the original image data according to the modifying parameters, thereby yielding a modified image; and
outputting the modified image on a display unit.

6. The method as claimed in claim 5, wherein the modifying parameters comprise a total modification result of the modified image relative to the original image.

7. The method as claimed in claim 5, wherein the modifying parameters comprises at least one modifying instructions that are initially produced by a control panel and then are stored in the image modification file.

8. An apparatus for processing and storing digital image, comprising:
a display unit;
a processing unit; and
a control panel;
wherein, the processing unit receives an image select instruction from the control panel, reads original image data of an original image from an original image file and outputs an image on the display unit, the image is the original image or a first modified image of the original image, the processing unit receives modifying instructions from the control panel and modifies data of the image according to the modifying instructions to produce a second modified image, the processing unit displays the second modified image on the display unit and saves modifying parameters relating to the modification in a image modification file.

9. The apparatus as claimed in claim 8, wherein the modification parameters comprise at least one total modification result of the second modified image relative to the original image of a same modifying instruction type.

10. The apparatus as claimed in claim 8, wherein the modification parameters comprise the modifying instructions.

11. The apparatus as claimed in claim 8, wherein the processing unit generates the image modification file before saves the modifying parameters in the image modification file.

12. The apparatus as claimed in claim 8, further comprises a storage for storing the original image file and the image modification file.

13. The apparatus as claimed in claim 8, further comprises a first storage for storing the original image file and a second storage for storing the image modification file.

14. An apparatus for displaying digital images, comprises:
a display unit;
a processing unit; and
an control panel;
wherein, the processing unit receives an image selection signal from the control panel and reads original image data of a original image from an original image file according to the image selection signal, the processing unit reads modifying parameters from an image modification file that corresponds to the original image file, the processing unit modifies the original image according to modifying parameters to produce a modified image and outputs the modified image to the display unit.

15. The apparatus as claimed in claim 14, wherein the modifying parameters comprise a total modification result of the modified image relative to the original image.

16. The apparatus as claimed in claim 14, wherein the modification parameters comprise modifying instructions that are initially produced by the control panel and then stored in the image modification file.

17. The apparatus as claimed in claim 14, further comprising a storage for storing the original image file and the image modification file.

18. The apparatus as claimed in claim 14, further comprising a first storage for storing the original image file and a second storage for storing the image modification file.
